(19) United States
(12) Patent Application Publication
(10) Pub. No.: US 2016/0271934 A1
(43) Pub. Date: Sep. 22, 2016

(54) RECORDING APPARATUS

(71) Applicant: SEIKO EPSON CORPORATION, Tokyo (JP)

(72) Inventor: Toru FUJITA, Matsumoto (JP)

(21) Appl. No.: 15/067,249

(22) Filed: Mar. 11, 2016

(30) Foreign Application Priority Data
Mar. 20, 2015 (JP) 2015-057807

(51) Int. Cl. B41J 2/045

(52) U.S. Cl. CPC B41J 2/04505; B41J 2/04586

(57) ABSTRACT

A recording apparatus includes a scanning unit which is provided with a first nozzle column which can eject first ink in ink, and a second nozzle column which can eject colorless second ink in the ink as nozzle columns which are configured of a plurality of aligned nozzles which can eject the ink on a medium, and can move in a scanning direction; and a control unit which can control ejecting of the ink from the nozzle column, in which the first nozzle column and the second nozzle column are respectively configured of the nozzles which are aligned in a direction which intersects the scanning direction, and are arranged at an overlapping position when viewed in the scanning direction, and the control unit causes the second ink to be ejected from the second nozzle column while moving the scanning unit in the scanning direction.

### BACKGROUND

1. Technical Field

The present invention relates to a recording apparatus.

2. Related Art

In the related art, a recording apparatus which performs recording by ejecting ink onto a recording medium (medium) from nozzles has been disclosed. In such a recording apparatus, there has been a case in which ink mist is attached to a forming portion of nozzles, or the like, and is accumulated, and the recording medium is contaminated due to dripping of the ink mist on the recording medium. For this reason, a technology in which attaching of ink mist to the forming portion of nozzles, or the like, is suppressed is disclosed.

For example, in JP-A-2014-208424, a recording apparatus in which it is possible to suppress attaching of ink mist to a forming portion of nozzles, or the like, in ejecting of ink which is executed separately from ejecting of ink for recording (dummy ejecting) is disclosed.

In a recording apparatus in recent years, recording of various forms is executed with respect to recording media of various types. For example, there is a case in which recording is executed so that ink sufficiently permeates into cloth as a recording medium, not only on a recording face onto which ink is ejected, but also on a face on a side opposite to the recording face. In such a case, permeation ink for causing ink for image forming to sufficiently permeate into the face on the side opposite to the recording face is ejected onto a recording medium, in addition to the ink for image forming. Here, in general, a use amount (ejecting amount) of the permeation ink becomes large in many cases. When the permeation ink of a large amount is ejected, there has been a case in which an air stream which is generated along with a movement of ink droplets in the air forms an air curtain (curtain of the permeation ink), an escape route of ink mist which occurs due to the ink for image forming is shut off, and the ink mist is attached to the formation portions of nozzles.

In the recording apparatus in the related art such as the recording apparatus which is disclosed in JP-A-2014-208424, a configuration in which it is possible to suppress such attaching of ink mist is not provided, and an effect of suppressing attaching of ink mist is insufficient.

### SUMMARY

An advantage of some aspects of the invention is to suppress attaching of ink mist.

According to an aspect of the invention, there is provided a recording apparatus which includes a scanning unit which is provided with a first nozzle column which can eject first ink in ink, and a second nozzle column which can eject colorless second ink in the ink as nozzle columns which are configured of a plurality of aligned nozzles which can eject the ink on a medium, and can move in a scanning direction; and a control unit which can control ejecting of the ink from the nozzle columns, in which the first nozzle column and the second nozzle column are respectively configured of the nozzles which are aligned in a direction which intersects the scanning direction, and are arranged at an overlapping position when viewed in the scanning direction, and the control unit causes the second ink to be ejected from the second nozzle column while moving the scanning unit in the scanning direction, and causes the first ink to be ejected from the first nozzle column in the middle of the movement after ejecting of the second ink with respect to an ejecting region of the second ink in the middle of the movement.

In the recording apparatus, the scanning unit may be able to reciprocate in the scanning direction, at least one of the first nozzle column and the second nozzle column may be provided in plural, in both directions of an outward direction and a return direction in the scanning direction, the first nozzle column is arranged on the rear side of the second nozzle column, and the control unit may switch a nozzle column which ejects the ink in at least one of the first nozzle column and the second nozzle column between a movement of the scanning unit toward the outward direction and a movement of the scanning unit toward the return direction.

In the recording apparatus, the first nozzle column may be provided on both sides of the second nozzle column in the scanning direction.

In the recording apparatus, the second nozzle column may be provided on both sides of the first nozzle column in the scanning direction.

In the recording apparatus, the first nozzle column may be provided on one side of the second nozzle column in the scanning direction, the scanning unit may be able to reciprocate in the scanning direction, and when the ink is ejected from the first nozzle column and the second nozzle column while moving the scanning unit in the outward direction and the return direction in the scanning direction, the control unit may cause the ink to be ejected from the first nozzle column and the second nozzle column in a direction in which the first nozzle column is located on the rear side of the second nozzle column in the scanning direction in the middle of the movement.

In the recording apparatus, the scanning unit may include a recording head in which both the first nozzle column and the second nozzle column are provided.

In the recording apparatus, the scanning unit may include a recording head in which the first nozzle column is provided, and a recording head in which the second nozzle column is provided.

According to the invention, it is possible to suppress attaching of ink mist.

### BRIEF DESCRIPTION OF THE DRAWINGS

Embodiments of the invention will now be described by way of example only with reference to the accompanying drawings, wherein like numbers reference like elements.

FIG. 1 is a schematic side view of a recording apparatus according to a first embodiment of the invention.

FIG. 2 is a block diagram which illustrates the recording apparatus according to the first embodiment of the invention.

FIGS. 3A to 3C are schematic views which illustrate main portions of the recording apparatus according to the first embodiment of the invention.

FIGS. 4A to 4C are schematic views which illustrate main portions of a recording apparatus according to a second embodiment of the invention.

FIGS. 5A to 5C are schematic views which illustrate main portions of a recording apparatus according to a third embodiment of the invention.

FIGS. 6A to 6C are schematic views which illustrate main portions of a recording apparatus according to a fourth embodiment of the invention.

FIGS. 7A and 7B are schematic views which illustrate main portions of a recording apparatus according to a fifth embodiment of the invention.

FIGS. 8A and 8B are schematic views which illustrate main portions of a recording apparatus according to a sixth embodiment of the invention.

### DESCRIPTION OF EXEMPLARY EMBODIMENTS

### First Embodiment

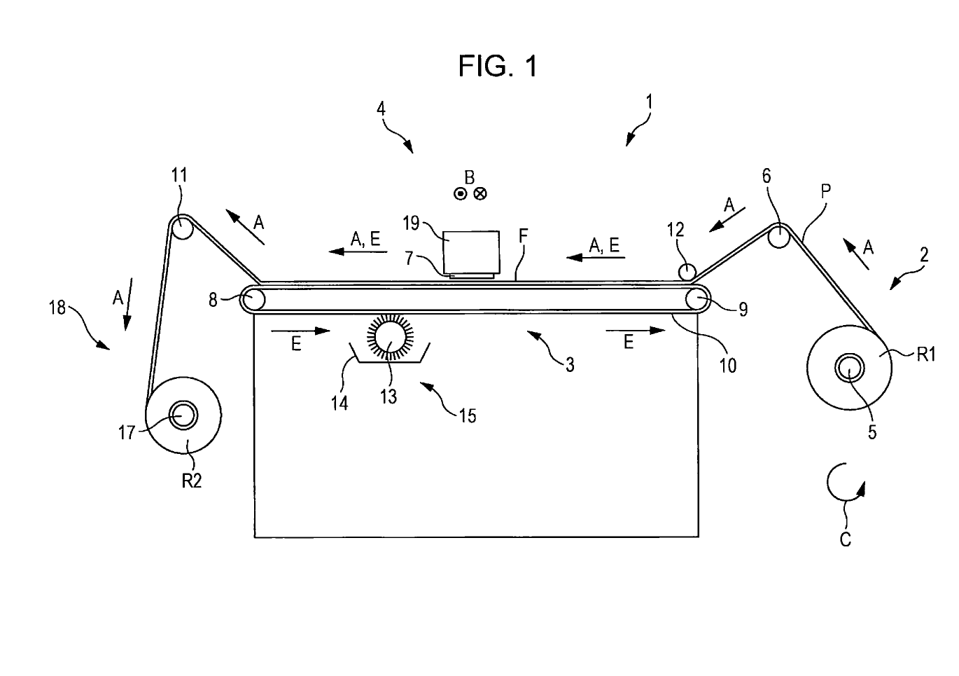

### (FIGS. 1 to 3C)

Hereinafter, a recording apparatus according to a first embodiment of the invention will be described in detail with reference to accompanying drawings.

First, an outline of a recording apparatus 1 according to the first embodiment of the invention will be described.

FIG. 1 is a schematic side view of the recording apparatus 1 according to the first embodiment.

The recording apparatus 1 according to the embodiment includes a feeding unit 2 which can send out a roll R1 of a recording medium (medium) P for performing recording. The recording apparatus further includes a transport mechanism 3 which transports the recording medium P in a transport direction A using an adhesive belt 10 (endless belt) which supports the recording medium P on a support face F onto which an adhesive is attached. The recording apparatus further includes a recording mechanism 4 which performs recording by causing a carriage 19 as a scanning unit which includes a recording head 7 to perform reciprocating scanning in a scanning direction B which intersects the transport direction A of the recording medium P. The recording apparatus further includes a washing mechanism 15 of the adhesive belt 10. In addition, the recording apparatus further includes a winding mechanism 18 including a winding shaft 17 which winds up the recording medium P.

The feeding unit 2 includes a rotating shaft 5 as a setting position of the roll R1 of the recording medium P for performing recording, and can feed the recording medium P to the transport mechanism 3 through a driven roller 6 from the roll R1 which is set in the rotating shaft 5. In addition, when feeding the recording medium P to the transport mechanism 3, the rotating shaft 5 rotates in a rotation direction C.

The transport mechanism 3 includes the adhesive belt 10 which transports the recording medium P which is fed from the feeding unit 2 by mounting the medium thereon, and a driving roller 8 and a driven roller 9 which move the adhesive belt 10 in a direction E. The recording medium P is mounted on the support face F of the adhesive belt 10 by being pressurized and attached using a pressurizing roller 12. In addition, when transporting the recording medium P, the driving roller 8 rotates in the rotation direction C.

However, the endless belt as a transport belt is not limited to the adhesive belt. For example, an electrostatic suctioning-type endless belt may be used.

The recording apparatus 1 according to the embodiment has a configuration in which it is possible to use cloth as the recording medium P, by including the transport mechanism with such a configuration. However, it is not limited to the transport mechanism with such a configuration, and may be a transport mechanism with a configuration in which the recording medium P is transported by being supported by a movable support tray, or a configuration in which the recording medium P is transported using a pair of rollers, or the like. In addition, it may be a recording apparatus of a so-called flatbed type in which recording is performed by fixing the recording medium P to a support unit, and the recording head is moved with respect to the fixed recording medium.

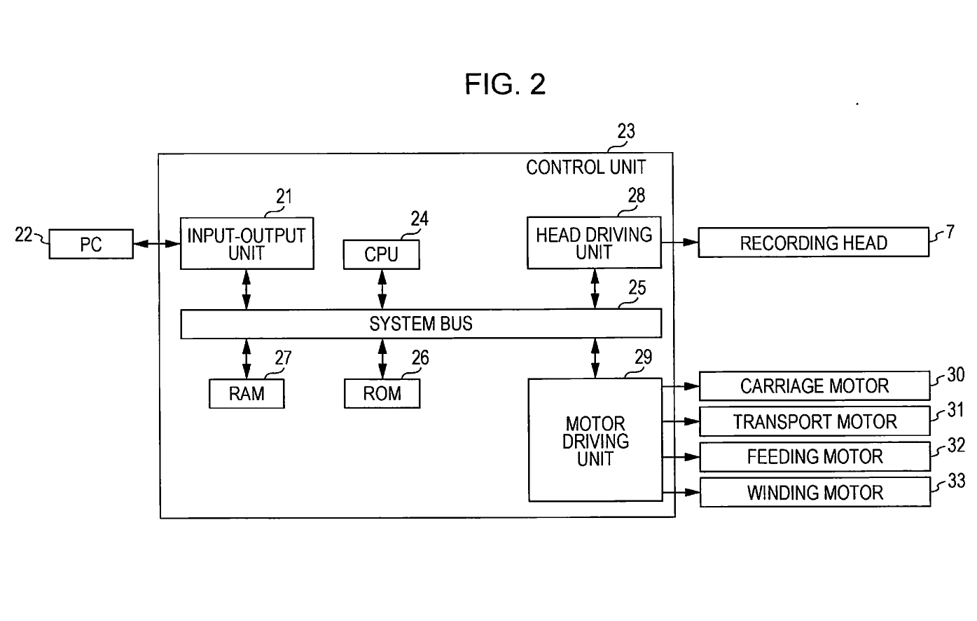

The recording mechanism 4 includes a carriage motor 30 (refer to FIG. 2) which causes the carriage 19 including the recording head 7 to reciprocate in the scanning direction B. In addition, in FIG. 1, the scanning direction B is a direction perpendicular to a plane on which FIG. 1 is represented.

When performing recording, the carriage 19 including the recording head 7 is caused to perform reciprocating scanning; however, the transport mechanism 3 stops transporting of the recording medium P in the middle of scanning for recording (in the middle of moving of carriage 19). In other words, when performing recording, reciprocating scanning of the carriage 19 and transporting of the recording medium P are alternately performed. That is, when performing recording, the transport mechanism 3 causes the recording medium P to be intermittently transported (intermittent movement of adhesive belt 10) corresponding to reciprocating scanning of the carriage 19.

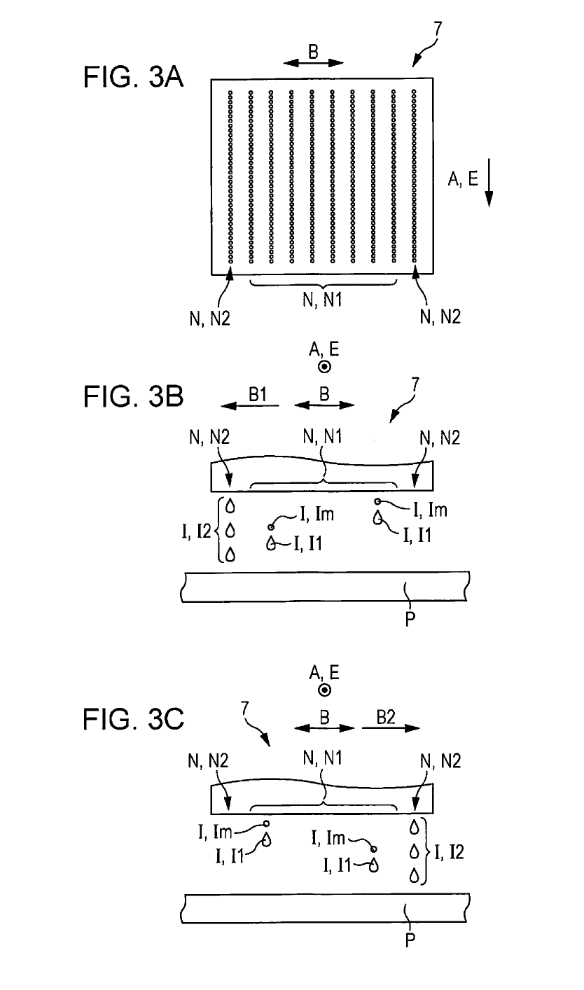

In addition, though it will be described in detail later, the recording apparatus 1 according to the embodiment has a configuration in which it is possible to perform recording by ejecting permeation ink as second ink I2 (refer to FIGS. 3A to 3C) from the recording head 7, in addition to color ink for image forming as first ink I1 (refer to FIGS. 3A to 3C). For this reason, it is a configuration in which it is possible to perform recording so that ink I sufficiently permeates onto a face on a side opposite to a recording face, not only the recording face onto which the ink I (refer to FIGS. 3A to 3C) is ejected, when cloth is used as the recording medium P, for example.

The washing mechanism 15 of the adhesive belt 10 includes a washing brush 13 to which a plurality of washing rollers are connected in a rotating shaft direction, and a tray 14 in which a detergent for washing the washing brush 13 is filled.

The winding mechanism 18 is a mechanism which winds up the recording medium P on which recording is performed, and which is transported from the transport mechanism 3 through a driven roller 11, and can wind up the medium as a roll R2 of the recording medium P, by setting a paper tube for winding on the winding shaft 17, and winding the recording medium P around the paper tube.

Subsequently, an electrical configuration in the recording apparatus 1 according to the embodiment will be described.

FIG. 2 is a block diagram of the recording apparatus 1 according to the embodiment.

A CPU 24 which is in charge of control of the entire recording apparatus 1 is provided in the control unit 23. The CPU 24 is connected to a ROM 26 which stores various control programs, or the like, which are executed by the CPU 24, and a RAM 27 which can temporarily store data through a system bus 25.

In addition, the CPU 24 is connected to a head driving unit 28 for driving the recording head 7 through the system bus 25.

The CPU 24 is connected to a motor driving unit 29 for driving the carriage motor 30, a transport motor 31, a feeding motor 32, and a winding motor 33 through the system bus 25.

Here, the carriage motor 30 is a motor for moving the carriage 19 including the recording head 7. In addition, the transport motor 31 is a motor for driving the driving roller 8. The feeding motor 32 is a motor which is a rotation mechanism of the rotating shaft 5, and which drives the rotating shaft 5 for sending the recording medium P to the transport mechanism 3. In addition, the winding motor 33 is a driving motor for rotating the winding shaft 17.

In addition, the CPU 24 is connected to an input-output unit 21 through the system bus 25, and the input-output unit 21 is connected to a PC 22 for performing transceiving of data such as recording data, and a signal.

Subsequently, the carriage 19 which is a main portion of the recording apparatus 1 according to the embodiment will be described.

FIGS. 3A to 3C are schematic views which illustrate the recording head 7 which is provided in the carriage 19 according to the embodiment. Among these, FIG. 3A is a schematic bottom view of the recording head 7, and FIGS. 3B and 3C are schematic front views of the recording head 7.

As described above, the recording apparatus 1 according to the embodiment can perform recording by ejecting the first ink I1 as color ink for image forming, and the second ink I2 as permeation ink from the recording head 7. Here, the second ink I2 as the permeation ink is ink which supports permeation of the first ink I1 as the color ink for image forming with respect to the recording medium P, and is substantially colorless ink which does not contain a coloring material of an effective amount. In addition, as illustrated in FIG. 3A, the recording head 7 according to the embodiment is provided with a first nozzle column N1 which ejects the first ink I1, and a second nozzle column N2 which ejects the second ink I2 as nozzle columns N. In detail, the first nozzle column N1 and the second nozzle column N2 are arranged at an overlapping position when viewed in the scanning direction B, and the first nozzle column N1 is provided so as to interpose the second nozzle column N2 in the scanning direction B. In this specification, the expression “nozzle column” includes a plurality of nozzle columns. In this embodiment, the second nozzle column N2 lies on either side of the first nozzle column N1.

In general, in many cases, a use amount (ejecting amount) of the permeation ink (second ink I2) becomes large. For this reason, in a recording apparatus in the related art, there has been a case in which an escape route of ink mist Im which is caused by the ink for image forming (first ink I1) is shut off due to a curtain of the permeation ink which occurs along with ejecting of too much permeation ink, and the ink mist Im is attached to a forming portion of a nozzle.

Therefore, the recording apparatus 1 according to the embodiment has a configuration in which it is possible to perform recording so that an escape route of the ink mist Im which is caused by the first ink I1 is not shut off because of the curtain of the second ink I2, by controlling ejecting of the ink I from the first nozzle column N1 and the second nozzle column N2 using the control unit 23.

Specifically, when recording is performed while moving the carriage 19 in the outward direction B1 in the scanning direction B (causing ink I to be ejected), as illustrated in FIG. 3B, recording is performed using the first nozzle column N1, and the second nozzle column N2 on the front side in the outward direction B1. In addition, when recording is performed while moving the carriage 19 in the return direction B2 in the scanning direction B, recording is performed using the first nozzle column N1, and the second nozzle column N2 on the front side in the return direction B2, as illustrated in FIG. 3C. In addition, a correlation between the outward direction B1 and the return direction B2 may be the reverse of that in the figure.

By performing recording in this manner, it is possible to suppress forming of a curtain of the second ink I2 on the rear side (downstream side) in a movement direction of the carriage 19. For this reason, it is possible to perform recording so that an escape route of the ink mist Im which is caused by the first ink I1 is not shut off because of the curtain of the second ink I2.

In addition, a curtain of the second ink I2 is formed on the front side (upstream side) in the movement direction of the carriage 19; however, since the ink mist Im which is caused by the first ink I1 can escape to the rear side (downstream side) in the movement direction of the carriage 19, it is possible to suppress attaching of the ink mist Im to the recording head 7.

In conclusion, the recording apparatus 1 according to the embodiment is provided with the first nozzle column N1 which can eject the first ink I1 in the ink I, and the second nozzle column N2 which can eject the second ink I2 in the ink I as nozzle columns N which are configured of a plurality of aligned nozzles which can eject the ink I onto the recording medium P, and includes the carriage 19 which can move in the scanning direction B. In addition, the recording apparatus includes the control unit 23 which can control ejecting of the ink I from the nozzle column N.

Here, as illustrated in FIG. 3A, the first nozzle column N1 and the second nozzle column N2 in which nozzles are aligned in a direction intersecting the scanning direction B are respectively configured, and are arranged at an overlapping position when viewed in the scanning direction B.

In addition, the control unit 23 can cause the second ink I2 to be ejected from the second nozzle column N2 while moving the carriage 19 in the scanning direction B, and cause the first ink I1 to be ejected from the first nozzle column N1 during the movement, after ejecting of the second ink I2, with respect to an ejecting region of the second ink I2 during the movement. That is, it is possible to cause the first ink I1 to be ejected from the first nozzle column N1 which is located on the rear side of the second nozzle column N2 in the scanning direction B, during the movement.

When the control unit 23 performs such an ejecting control of the ink I, it is possible to suppress a situation in which an escape route of the ink mist Im (rear side in scanning direction B) caused by the color ink for image forming (first ink I1) is shut off, which is caused by a curtain of permeation ink which occurs along with ejecting of too much permeation ink (second ink I2). For this reason, the recording apparatus 1 according to the embodiment is configured so as to suppress attaching of the ink mist Im.

In addition, in the carriage 19 according to the embodiment, a plurality of the first nozzle columns N1 are arranged so as to be interposed between respective second nozzle column N2; however, it is not limited to such a configuration, and it may be an arrangement of interposing one first nozzle column N1 between respective second nozzle columns N2, an arrangement of interposing one first nozzle column N1 between a respective plurality of second nozzle columns N2, an arrangement of interposing a plurality of the first nozzle columns N1 between a respective plurality of second nozzle columns N2, and the like.

In other words, in the recording apparatus 1 according to the embodiment, the carriage 19 can reciprocate in the scanning direction B. In addition, at least one of the first nozzle column N1 and the second nozzle column N2 is provided in plural, and the first nozzle column N1 is arranged so as to be located on the rear side of the second nozzle column N2 in both directions of the outward direction B1 and the return direction B2 in the scanning direction B. In addition, the control unit 23 can switch a nozzle column N which ejects the ink I in at least one of the first nozzle column N1 and the second nozzle column N2, using a movement of the carriage 19 to the outward direction B1 and a movement of the carriage 19 to the return direction B2. Specifically, switching is performed so that the ink I is ejected from the second nozzle column N2 on the front side, relative to the first nozzle column N1 in both directions of the outward direction B1 and the return direction B2 in the scanning direction B.

For this reason, by adopting such a configuration, it is possible to eject the ink I in both directions of the outward direction B1 and the return direction B2 in the scanning direction B, and to suppress attaching of the ink mist Im in both the directions by suppressing shutting off of an escape route of ink mist Im on the rear side in the scanning direction B.

In addition, as illustrated in FIG. 3A, the second nozzle columns N2 are provided on both sides of the first nozzle column N1 in the scanning direction B. That is, by providing the second nozzle columns N2 on both sides of the first nozzle column N1 in the scanning direction B, as illustrated in FIGS. 3B and 3C, forming of a curtain of the second ink I2 on the rear side in a movement direction of the carriage 19 is suppressed, and attaching of the ink mist Im is suppressed in both directions of the outward direction B1 and the return direction B2 in the scanning direction B.

As illustrated in FIG. 3A, the carriage 19 according to the embodiment includes the recording head 7 which is provided with both the first nozzle column N1 and the second nozzle column N2. In this manner, the recording apparatus 1 according to the embodiment suppresses attaching of the ink mist Im in a configuration of including the recording heads 7 which is provided with both the first nozzle column N1 and the second nozzle column N2 in the carriage 19. However, it is not limited to such a configuration.

### Second Embodiment

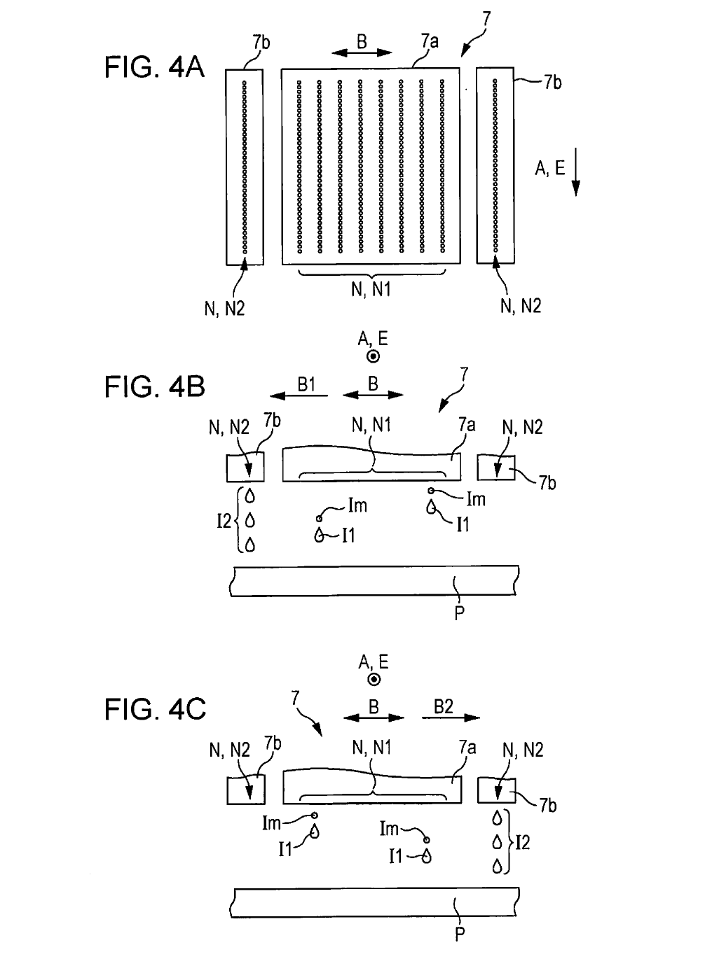

### (FIGS. 4A to 4C)

Subsequently, a recording apparatus according to a second embodiment of the invention will be described.

FIGS. 4A to 4C are schematic views which illustrate a recording head 7 which is provided in a carriage 19 as a main portion of a recording apparatus 1 according to the second embodiment of the invention. Among these, FIG. 4A is a schematic bottom view of the recording head 7, and corresponds to FIG. 3A which illustrates the recording apparatus 1 according to the first embodiment. In addition, FIGS. 4B and 4C are schematic front views of the recording head 7, and correspond to FIGS. 3B and 3C which illustrate the recording apparatus 1 according to the first embodiment.

In addition, constituent elements which are common to those in the first embodiment will be given the same reference numerals, and detailed descriptions will be omitted.

The recording apparatus 1 according to the embodiment is different from the recording apparatus 1 according to the first embodiment only in a configuration of the recording head 7 which is provided in the carriage 19.

The carriage 19 according to the first embodiment is provided with the recording head 7 in which both the first nozzle column N1 and the second nozzle column N2 are provided.

On the other hand, as illustrated in FIGS. 4A to 4C, the carriage 19 according to the embodiment has a configuration of including a recording head 7a in which the first nozzle column N1 is provided, and two recording heads 7b in which the second nozzle column N2 is provided as the recording head 7.

As illustrated in FIGS. 4A to 4C, the recording apparatus 1 according to the embodiment includes the carriage 19 which has the recording head 7a in which the first nozzle column N1 is provided, and the recording head 7b in which the second nozzle column N2 is provided. In addition, a positional relationship between the first nozzle column N1 and the second nozzle column N2, and a control method thereof are the same as those in the carriage 19 according to the first embodiment.

That is, the recording apparatus 1 according to the embodiment has a configuration of suppressing attaching of the ink mist Im, similarly to the recording apparatus according to the first embodiment, in a configuration in which the carriage 19 includes the recording head 7a in which the first nozzle column N1 is provided, and the recording head 7b in which the second nozzle column N2 is provided.

### Third Embodiment

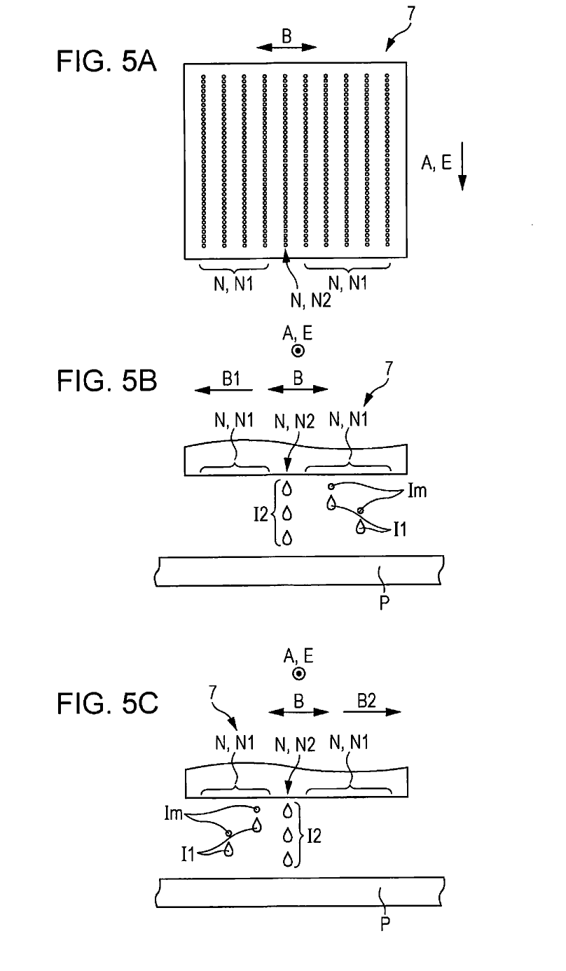

### (FIGS. 5A to 5C)

Subsequently, a recording apparatus according to a third embodiment of the invention will be described.

FIGS. 5A to 5C are schematic views which illustrate a recording head 7 which is provided in a carriage 19 as a main portion of a recording apparatus 1 according to the third embodiment of the invention. Among these, FIG. 5A is a schematic bottom view of the recording head 7, and corresponds to FIG. 3A which illustrates the recording apparatus 1 according to the first embodiment. In addition, FIGS. 5B and 5C are schematic front views of the recording head 7, and correspond to FIGS. 3B and 3C which illustrate the recording apparatus 1 according to the first embodiment.

In addition, constituent elements which are common to those in the first and the second embodiments will be given the same reference numerals, and detailed descriptions will be omitted.

The recording apparatus 1 according to the embodiment is different from the recording apparatus 1 according to the first and second embodiments only in a configuration of the recording head 7 which is provided in a carriage 19, and a control method thereof.

The carriage 19 according to the first embodiment has a configuration of providing the second nozzle columns N2 on both sides of the first nozzle column N1 in the scanning direction B.

On the other hand, the carriage 19 according to the embodiment has a configuration of providing the first nozzle columns N1 on both sides of the second nozzle column N2 in the scanning direction B, as illustrated in FIGS. 5A to 5C.

As illustrated in FIGS. 5A to 5C, in the recording apparatus 1 according to the embodiment, the first nozzle columns N1 are provided on both sides of the second nozzle column N2 in the scanning direction B. In addition, when recording is performed while moving the carriage 19 in the outward direction B1 in the scanning direction B, as illustrated in FIG. 5B, recording is performed using the second nozzle column N2, and the first nozzle column N1 on the rear side in the outward direction B1. In addition, when recording is performed while moving the carriage 19 in the return direction B2 in the scanning direction B, as illustrated in FIG. 5C, recording is performed using the second nozzle column N2, and the first nozzle column N1 on the rear side in the return direction B2.

That is, the recording apparatus 1 according to the embodiment can suppress attaching of the ink mist Im, similarly to the recording apparatus 1 according to the first embodiment, in a configuration in which the first nozzle columns N1 are provided on both sides of the second nozzle column N2 in the scanning direction B.

### Fourth Embodiment

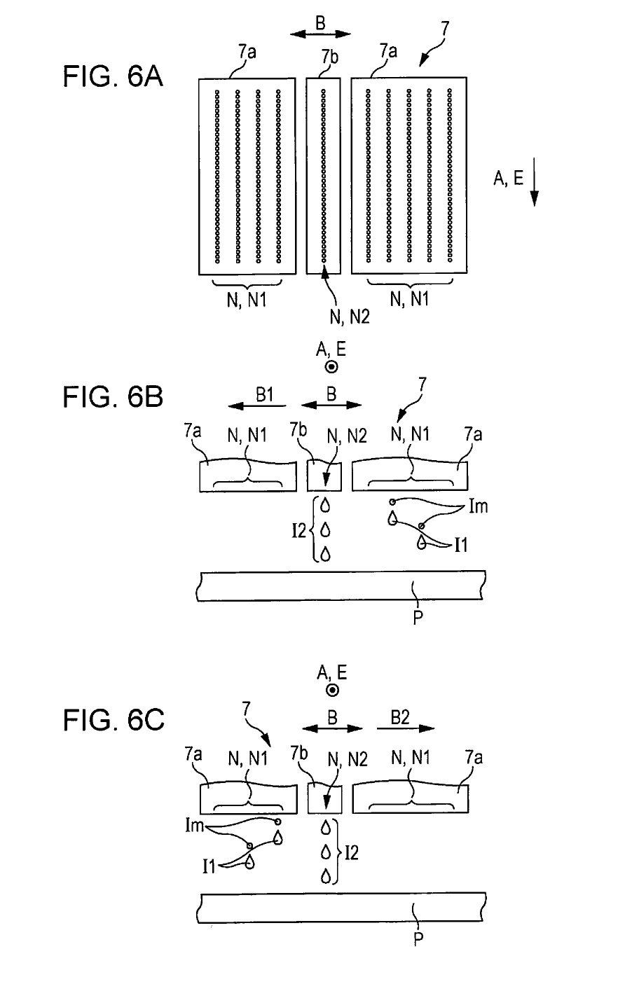

### (FIGS. 6A to 6C)

Subsequently, a recording apparatus according to a fourth embodiment of the invention will be described.

FIGS. 6A to 6C are schematic views which illustrate a recording head 7 which is provided in a carriage 19 as a main portion of a recording apparatus 1 according to the fourth embodiment of the invention. Among these, FIG. 6A is a schematic bottom view of the recording head 7, and corresponds to FIG. 3A which illustrates the recording apparatus 1 according to the first embodiment. In addition, FIGS. 6B and 6C are schematic front views of the recording head 7, and correspond to FIGS. 3B and 3C which illustrate the recording apparatus 1 according to the first embodiment.

In addition, constituent elements which are common to those in the first to third embodiments will be given the same reference numerals, and detailed descriptions will be omitted.

The recording apparatus 1 according to the embodiment is different from the recording apparatus 1 according to the third embodiment only in a configuration of the recording head 7 which is provided in the carriage 19.

The carriage 19 according to the third embodiment has a configuration of including the recording head 7 in which both the first nozzle column N1 and the second nozzle column N2 are provided.

On the other hand, as illustrated in FIGS. 6A to 6C, the carriage 19 according to the embodiment has a configuration of including two recording heads 7a in which the first nozzle columns N1 are provided, and a recording head 7b in which the second nozzle column N2 is provided as the recording head 7. In addition, a positional relationship between the first nozzle column N1 and the second nozzle column N2, and a control method thereof are the same as those in the carriage 19 according to the third embodiment.

That is, the recording apparatus 1 according to the embodiment can suppress attaching of the ink mist Im, similarly to the recording apparatus according to the third embodiment.

### Fifth Embodiment

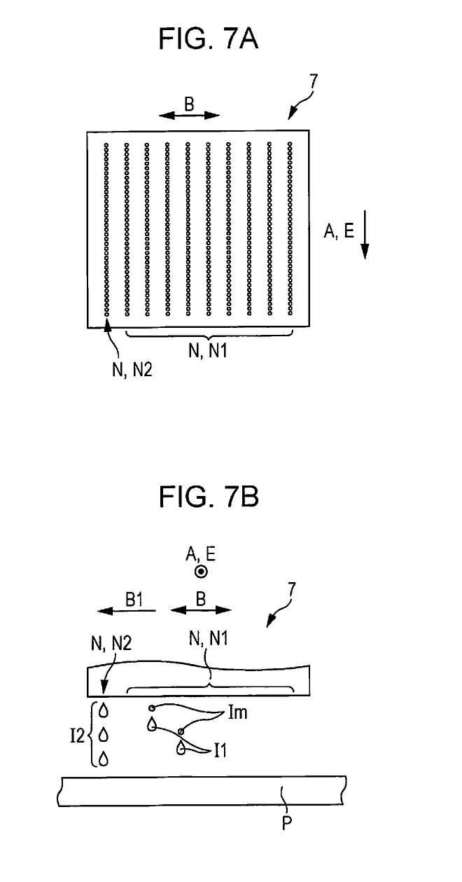

### (FIGS. 7A and 7B)

Subsequently, a recording apparatus according to a fifth embodiment of the invention will be described.

FIGS. 7A and 7B are schematic views which illustrate a recording head 7 which is provided in a carriage 19 as a main portion of a recording apparatus 1 according to the fifth embodiment of the invention. In these figures, FIG. 7A is a schematic bottom view of the recording head 7, and corresponds to FIG. 3A which illustrates the recording apparatus 1 according to the first embodiment. In addition, FIG. 7B is a schematic front view of the recording head 7, and corresponds to FIG. 3B which illustrates the recording apparatus 1 according to the first embodiment.

In addition, constituent elements which are common to those in the first to fourth embodiments will be given the same reference numerals, and detailed descriptions will be omitted.

The recording apparatus 1 according to the embodiment is different from the recording apparatus 1 according to the first to fourth embodiments only in a configuration of the recording head 7 which is provided in the carriage 19, and a control method thereof.

The carriage 19 according to the first and the second embodiments has a configuration in which the second nozzle columns N2 are provided on both sides of the first nozzle column N1 in the scanning direction B. In addition, the carriage 19 according to the third and fourth embodiments has a configuration in which the first nozzle columns N1 are provided on both sides of the second nozzle columns N2 in the scanning direction B.

On the other hand, as illustrated in FIGS. 7A and 7B, the carriage 19 according to the embodiment has a configuration in which the second nozzle column N2 is provided only on one side of the first nozzle column N1 in the scanning direction B.

As illustrated in FIGS. 7A and 7B, in the recording apparatus 1 according to the embodiment, the first nozzle column N1 is provided on one side of the second nozzle column N2 in the scanning direction B. In addition, similarly to the recording apparatuses in the first to fourth embodiments, the carriage 19 can reciprocate in the scanning direction B.

Here, when the ink I is ejected from the first nozzle column N1 and the second nozzle column N2 while moving the carriage 19 in the scanning direction B, the control unit 23 according to the embodiment causes the ink I to be ejected from the first nozzle column N1 and the second nozzle column N2 only in a movement in the outward direction B1, between the outward direction B1 and the return direction B2 in the scanning direction B, as illustrated in FIG. 7B. That is, when the ink I is ejected from the first nozzle column N1 and the second nozzle column N2 while moving the carriage 19 in the scanning direction B, the ink I is ejected from the first nozzle column N1 and the second nozzle column N2 in a direction in which the first nozzle column N1 is located on the rear side of the second nozzle column N2 in the scanning direction B.

It is possible to suppress forming of a curtain of the second ink I2 on the rear side in a movement direction of the carriage 19, and to suppress attaching of the ink mist Im when the control unit 23 performs control in this manner. For this reason, the recording apparatus 1 according to the embodiment can suppress attaching of the ink mist Im without increasing the number of nozzle columns N.

### Sixth Embodiment

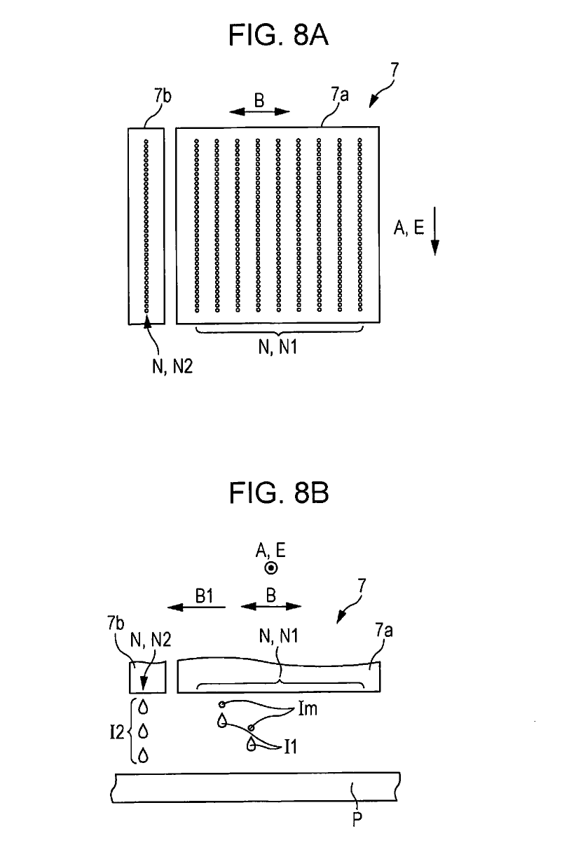

### (FIGS. 8A and 8B)

Subsequently, a recording apparatus according to a sixth embodiment will be described.

FIGS. 8A and 8B are schematic views which illustrate a recording head 7 which is provided in a carriage 19 as a main portion of a recording apparatus 1 according to the sixth embodiment of the invention. In these figures, FIG. 8A is a schematic bottom view of the recording head 7, and corresponds to FIG. 3A which illustrates the recording apparatus 1 according to the first embodiment. In addition, FIG. 8B is a schematic front view of the recording head 7, and corresponds to FIG. 3B which illustrates the recording apparatus 1 according to the first embodiment.

In addition, constituent elements which are common to those in the first to fifth embodiments will be given the same reference numerals, and detailed descriptions will be omitted.

The recording apparatus 1 according to the embodiment is different from the recording apparatus 1 according to the fifth embodiment only in a configuration of the recording head 7 which is provided in the carriage 19.

The carriage 19 according to the fifth embodiment has a configuration including the recording head 7 in which both the first nozzle column N1 and the second nozzle column N2 are provided.

On the other hand, as illustrated in FIGS. 8A and 8B, the carriage 19 according to the embodiment has a configuration including a recording head 7a in which the first nozzle columns N1 are provided, and a recording head 7b in which the second nozzle column N2 is provided as the recording head 7. In addition, a positional relationship between the first nozzle column N1 and the second nozzle column N2, and a control method thereof are the same as those in the carriage 19 according to the fifth embodiment.

That is, the recording apparatus 1 according to the embodiment can suppress attaching of the ink mist Im, similarly to the recording apparatus according to the fifth embodiment.

In addition, the invention is not limited to the above described embodiments, and can be variously modified in the scope of the invention which is described in claims, and it is needless to say that those are also included in the scope of the invention.

Hitherto, the invention has been described in detail based on specific embodiments. Here, the invention will be collectively described once again.

A recording apparatus 1 according to a first aspect of the invention includes a scanning unit 19 which is provided with a first nozzle column N1 which can eject first ink I1 in ink I, and a second nozzle column N2 which can eject colorless second ink I2 in the ink I as nozzle columns N which are configured of a plurality of aligned nozzles which can eject the ink I on a medium P, and can move in a scanning direction B; and a control unit 23 which can control ejecting of the ink I from the nozzle columns N, in which the first nozzle column N1 and the second nozzle column N2 are respectively configured of the nozzles which are aligned in a direction which intersects the scanning direction B, and are arranged at an overlapping position when viewed in the scanning direction B, and the control unit 23 causes the second ink I2 to be ejected from the second nozzle column N2 while moving the scanning unit 19 in the scanning direction B, and causes the first ink I1 to be ejected from the first nozzle column N1 in the middle of the movement after ejecting of the second ink I2 with respect to an ejecting region of the second ink I2 in the middle of the movement.

According to the aspect, the second ink I2 is ejected from the second nozzle column N2 while moving the scanning unit 19 in the scanning direction B, and the first ink I1 is ejected from the first nozzle column N1 during the movement after ejecting of the second ink I2 with respect to an ejecting region of the second ink I2 during the movement. That is, for example, the first ink I1 is ejected from the first nozzle column N1 which is located on the rear side of the second nozzle column N2 in the scanning direction B during the movement. For example, when color ink for image forming is used as the first ink I1, and permeation ink is used as the second ink I2, it is possible to suppress a situation in which an escape route of the ink mist Im (rear side in scanning direction B) caused by the color ink for image forming is shut off, which is caused by a curtain of permeation ink which occurs along with ejecting of too much permeation ink. In this way, the recording apparatus 1 according to the embodiment is configured so as to suppress attaching of the ink mist Im.

In the recording apparatus 1 according to a second aspect of the invention, in the first aspect, the scanning unit 19 can reciprocate in the scanning direction B, at least one of the first nozzle column N1 and the second nozzle column N2 is provided in plural, the first nozzle column N1 is arranged so as to be located on the rear side of the second nozzle column N2 in both directions of the outward direction B1 and the return direction B2 in the scanning direction B, and the control unit 23 switches a nozzle column N which ejects the ink I in at least one of the first nozzle column N1 and the second nozzle column N2, in a movement of the scanning unit 19 toward the outward direction B1, and a movement of the scanning unit 19 toward the return direction B2.

According to the aspect, in the scanning unit 19, at least one of the first nozzle column N1 and the second nozzle column N2 is provided in plural, and the first nozzle column N1 is arranged so as to be located on the rear side of the second nozzle column N2 in both directions of the outward direction B1 and the return direction B2 in the scanning direction B. In addition, the control unit 23 switches a nozzle column N which ejects the ink I in at least one of the first nozzle column N1 and the second nozzle column N2, in a movement of the scanning unit 19 toward the outward direction B1, and a movement of the scanning unit 19 toward the return direction B2. For this reason, with such a configuration, it is possible to eject the ink I in both directions of the outward direction B1 and the return direction B2 in the scanning direction B, and to suppress attaching of the ink mist Im in both the directions.

In the recording apparatus 1 according to a third aspect of the invention, in the second aspect, the first nozzle column N1 is provided on both sides of the second nozzle column N2 in the scanning direction B.

According to the aspect, the first nozzle column N1 is provided on both sides of the second nozzle column N2 in the scanning direction B. That is, it is possible to suppress attaching of the ink mist Im in both directions of the outward direction B1 and the return direction B2 in the scanning direction B, by providing the first nozzle column N1 on both sides of the second nozzle column N2 in the scanning direction B.

In the recording apparatus 1 according to a fourth aspect, in the second or third aspect, the second nozzle column N2 is provided on both sides of the first nozzle column N1 in the scanning direction B.

According to the aspect, the second nozzle column N2 is provided on both sides of the first nozzle column N1 in the scanning direction B. That is, it is possible to suppress attaching of the ink mist Im in both directions of the outward direction B1 and the return direction B2 in the scanning direction B, by providing the second nozzle column N2 on both sides of the first nozzle column N1 in the scanning direction B.

In the recording apparatus 1 according to a fifth aspect, in the first aspect, the first nozzle column N1 is provided on one side of the second nozzle column N2 in the scanning direction B, the scanning unit 19 can reciprocate in the scanning direction B, and when the ink I is ejected from the first nozzle column N1 and the second nozzle column N2 while moving the scanning unit 19 in the scanning direction B between the outward direction B1 and the return direction B2 in the scanning direction B, the control unit 23 causes the ink I to be ejected from the first nozzle column N1 and the second nozzle column N2 in a direction in which the first nozzle column N1 is located on the rear side of the second nozzle column N2 in the scanning direction B in the movement.

According to the aspect, the first nozzle column N1 is provided on one side of the second nozzle column N2 in the scanning direction B, and the ink I is ejected in a direction in which the first nozzle column N1 is located on the rear side of the second nozzle column N2 between the outward direction B1 and the return direction B2. For this reason, it is possible to suppress attaching of the ink mist Im without increasing the number of nozzle columns N.

In the recording apparatus 1 according to a sixth aspect, in any one of the first to fifth aspects, the scanning unit 19 includes the recording head 7 in which the first nozzle column N1 and the second nozzle column N2 are provided.

According to the aspect, the scanning unit 19 includes the recording head 7 in which the first nozzle column N1 and the second nozzle column N2 are provided. That is, it is possible to suppress attaching of the ink mist Im in the recording apparatus 1 in which the recording head 7 in which the first nozzle column N1 and the second nozzle column N2 are provided is included in the scanning unit 19.

In the recording apparatus 1 according to a seventh aspect, in any one of the first to sixth aspects, the scanning unit 19 includes a recording head 7a in which the first nozzle column N1 is provided, and a recording head 7b in which the second nozzle column N2 is provided.

According to the aspect, the scanning unit includes the recording head 7a in which the first nozzle column N1 is provided, and the recording head 7b in which the second nozzle column N2 is provided. That is, it is possible to suppress attaching of the ink mist Im in the recording apparatus 1 in which the recording head 7a in which the first nozzle column N1 is provided, and the recording head 7b in which the second nozzle column N2 is provided are included in the scanning unit 19.

The entire disclosure of Japanese Patent Application No.2015-057807, filed Mar. 20, 2015 is expressly incorporated by reference herein.

What is claimed is:

1. A recording apparatus comprising:
a scanning unit which is provided with a first nozzle column which is configured to eject first ink in ink, and a second nozzle column which is configured to eject substantially colorless second ink in the ink, as nozzle columns which are configured of a plurality of aligned nozzles which is configured to eject the ink on a medium, and is configured to move in a scanning direction; and
a control unit which is configured to control ejecting of the ink from the nozzle columns,
wherein the first nozzle column and the second nozzle column are respectively configured of the nozzles which are aligned in a direction which intersects the scanning direction, and are arranged at an overlapping position when viewed in the scanning direction, and
wherein the control unit is arranged to cause the second ink to be ejected from the second nozzle column while moving the scanning unit in the scanning direction, and to cause the first ink to be ejected from the first nozzle column during the movement after ejecting of the second ink with respect to an ejecting region of the second ink during the movement.

2. The recording apparatus according to claim 1,
wherein the scanning unit can reciprocate in the scanning direction,
wherein, at least one of the first nozzle column and the second nozzle column is provided in plural, and in both directions of an outward direction and a return direction in the scanning direction, the first nozzle column is arranged on the rear side of the second nozzle column, and
wherein the control unit is arranged to switch a nozzle column which ejects the ink in at least one of the first nozzle column and the second nozzle column between a movement of the scanning unit toward the outward direction and a movement of the scanning unit toward the return direction.

3. The recording apparatus according to claim 2,
wherein the first nozzle column is provided on both sides of the second nozzle column in the scanning direction.

4. The recording apparatus according to claim 2,
wherein the second nozzle column is provided on both sides of the first nozzle column in the scanning direction.

5. The recording apparatus according to claim 1,
wherein the first nozzle column is provided on one side of the second nozzle column in the scanning direction,
wherein the scanning unit can reciprocate in the scanning direction, and
wherein, when the ink is ejected from the first nozzle column and the second nozzle column while moving the scanning unit in the outward direction and the return direction in the scanning direction, the control unit is arranged to cause the ink to be ejected from the first nozzle column and the second nozzle column in a direction in which the first nozzle column is located on the rear side of the second nozzle column in the scanning direction in the middle of the movement.

6. The recording apparatus according to claim 1,
wherein the scanning unit includes a recording head in which both the first nozzle column and the second nozzle column are provided.

7. The recording apparatus according to claim 1,
wherein the scanning unit includes a recording head in which the first nozzle column is provided, and a recording head in which the second nozzle column is provided.
